(19) United States
(12) Patent Application Publication
(10) Pub. No.: US 2025/0378270 A1
(43) Pub. Date: Dec. 11, 2025

(54) INFORMATION PROCESSING APPARATUS, DETERMINATION METHOD, AND NON-TRANSITORY RECORDING MEDIUM

(71) Applicant: NEC Corporation, Tokyo (JP)

(72) Inventor: Yousuke MOTOHASHI, Tokyo (JP)

(73) Assignee: NEC Corporation, Tokyo (JP)

(21) Appl. No.: 19/223,195

(22) Filed: May 30, 2025

(30) Foreign Application Priority Data
Jun. 7, 2024 (JP) 2024-093257

(51) Int. Cl. G06F 40/20; G06N 20/00

(52) U.S. Cl. CPC G06F 40/20; G06N 20/00

(57) ABSTRACT

An information processing apparatus includes: at least one memory storing instructions; and at least one processor configured to execute the instructions to; input a first question sentence regarding a content of a target document to a language model updated by learning the content of the target document to generate a first answer sentence; and determine similarity between the first answer sentence and a second answer sentence generated by inputting the first question sentence to the language model before update. With the information processing apparatus, it is possible to efficiently generate a language model optimized for generating an answer sentence for the target document.

### INCORPORATION BY REFERENCE

This application is based upon and claims the benefit of priority from Japanese patent application No. 2024-093257, filed on Jun. 7, 2024, the disclosure of which is incorporated herein in its entirety by reference.

### TECHNICAL FIELD

The present disclosure relates to an information processing apparatus, a determination method, and a non-transitory recording medium.

### BACKGROUND ART

A technology for adapting a language model generated by machine learning of a natural language to a specific domain is known. Examples of the technology for adapting a language model to a specific domain include an information processing apparatus described in Japanese Unexamined Patent Application Publication No. 2023-72863, for example. The information processing apparatus extracts a domain-specific word, which is an expression peculiar to an industry, by using sample data, and acquires a sentence including the domain-specific word as learning target data. Then, a new language model is constructed by performing machine learning of the domain-specific word based on the acquired learning target data. As a result, it is possible to construct a language model capable of accurately interpreting technical terms, expressions peculiar to an industry, and the like.

### SUMMARY

The information processing apparatus described in Japanese Unexamined Patent Application Publication No. 2023-72863 has room for improvement in that the progress of training of the language model cannot be automatically determined. In a case where it is not possible to automatically determine the progress of training, the number and quality of the acquired learning target data become insufficient, and there may be a problem that it is not possible to appropriately interpret expressions peculiar to an industry even if a newly constructed language model is used. In addition, there may be a problem that the learning target data is excessively acquired, which results in an increase in cost of training in addition to an increase in cost for preparing the learning target data. Such a problem is not limited to sentences including the domain-specific word and occurs in common in a case where an arbitrary document is learned by the language model.

The present disclosure has been made in view of such a problem, and an example object of the present disclosure is to provide a technology capable of automatically determining the progress of training of a language model for a target document. An example object of the present disclosure is to provide an information processing apparatus, a determination method, and a non-transitory recording medium.

An information processing apparatus according to an example aspect of the present disclosure includes: at least one memory storing instructions; and at least one processor configured to execute the instructions to; input a first question sentence regarding a content of a document that is a target to a language model updated by machine learning using at least one piece of training data in which an answer sentence to a question sentence regarding the content of the document is associated with the question sentence to generate a first answer sentence; and determine similarity between the first answer sentence and a second answer sentence generated by inputting the first question sentence to the language model before update using the at least one piece of training data.

A determination method according to an example aspect of the present disclosure includes: generation control processing of inputting a first question sentence regarding a content of a document that is a target to a language model updated by machine learning using at least one piece of training data in which an answer sentence to a question sentence regarding the content of the document is associated with the question sentence to generate a first answer sentence; and determination processing of determining similarity between the first answer sentence and a second answer sentence generated by inputting the first question sentence to the language model before update using the at least one piece of training data.

A non-transitory recording medium recording a determination program according to an example aspect of the present disclosure causes a computer to perform: generation control processing of inputting a first question sentence regarding a content of a document that is a target to a language model updated by machine learning using at least one piece of training data in which an answer sentence to a question sentence regarding the content of the document is associated with the question sentence to generate a first answer sentence; and determination processing of determining similarity between the first answer sentence and a second answer sentence generated by inputting the first question sentence to the language model before update using the at least one piece of training data.

According to an example aspect of the present disclosure, there is an exemplary effect that the progress of training of a language model for a target document can be automatically determined.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of a determination method according to the present disclosure;

FIG. 3 is a block diagram illustrating a configuration of another information processing apparatus according to the present disclosure;

FIG. 4 is a flowchart illustrating an example of processing performed by the information processing apparatus illustrated in FIG. 3;

FIG. 5 is a flowchart illustrating details of processing of S12 in FIG. 4; and

FIG. 6 is a block diagram illustrating a configuration of a computer that functions as the information processing apparatus according to the present disclosure.

### EXAMPLE EMBODIMENT

Hereinafter, example embodiments according to the present disclosure will be exemplified. However, the present disclosure is not limited to the example embodiments described below, and various modifications can be made within the scope described in the claims. For example, example embodiments obtained by appropriately combining the technologies (some or all of the products or methods) adopted in the following example embodiments can also fall within the scope of the present disclosure. In addition, example embodiments obtained by appropriately omitting some of the technologies adopted in the following example embodiments can also fall within the scope of the present disclosure. In addition, the effects mentioned in the following example embodiments are examples of effects expected in the example embodiments, and do not define the extension of the present disclosure. That is, example embodiments that do not achieve the effects mentioned in the following example embodiments can also fall within the scope of the present disclosure.

### First Example Embodiment

A first example embodiment, which is an example of an example embodiment of the present disclosure, will be described in detail with reference to the drawings. The present example embodiment is a basic form of each example embodiment described below. An application range of each technology adopted in the present example embodiment is not limited to the present example embodiment. That is, each technology adopted in the present example embodiment can also be adopted in other example embodiments included in the present disclosure as long as no particular technical problem occurs. Each technology illustrated in the drawings referred to for describing the present example embodiment can also be adopted in other example embodiments included in the present disclosure as long as no particular technical problem occurs.

### (Configuration of Information Processing Apparatus 1)

A configuration of an information processing apparatus 1 according to the present example embodiment will be described with reference to FIG. 1. FIG. 1 is a block diagram illustrating a configuration of the information processing apparatus 1. As illustrated in FIG. 1, the information processing apparatus 1 includes a generation control unit 101 and a determination unit 102.

The generation control unit 101 inputs a first question sentence regarding a content of a document that is a target to a language model updated by machine learning using at least one piece of training data in which an answer sentence to a question sentence regarding the content of the document is associated with the question sentence to generate a first answer sentence. Hereinafter, the “document that is the target” is referred to as a “target document”.

The target document is a document to be learned by the language model and may include at least one sentence. For example, one or more sentences may be set as the target document, or a part of a sentence (for example, a chapter, a clause, or a paragraph) may be set as the target document. It can be said that the target document is a document indicating a domain to which the language model is to be adapted. For example, a manual to be used for a product or service may be used as the target document. It is possible to generate a language model capable of generating an answer sentence based on the manual for a question sentence regarding a content of the product or service by causing the language model to learn the manual. Furthermore, for example, a document describing a response procedure for injuries and illnesses may be set as the target document. It is possible to generate a language model capable of generating an answer sentence indicating an appropriate response procedure for a question sentence regarding the response procedure for injuries and illnesses by causing the language model to learn such a document. As described above, the information processing apparatus 1 can also be used for healthcare.

The language model before learning the target document may be, for example, a general-purpose language model obtained by machine learning of a sequence of constituent elements (words and the like) of a sentence described in a natural language and a sequence of sentences in a document. By updating (also referred to as fine tuning) the general-purpose language model using the training data in which an answer sentence to a question sentence regarding a content of the target document is associated with the question sentence, it is possible to generate a language model capable of generating an answer sentence based on the content of the target document for the question regarding the content of the target document.

However, in a case where learning of the target document is insufficient, an answer sentence may be generated based on existing knowledge already learned before learning the target document. In this case, the generated answer sentence is not based on the content of the target document. For example, in a case where a question sentence asking the year of establishment of a company is input to the language model obtained by learning the target document describing the history of the company, an answer sentence indicating the year of establishment described in the target document is expected to be generated. However, in a case where learning of the target document is insufficient, a general answer sentence such as “the year of establishment varies across companies” may be generated. In addition, an answer sentence indicating the year of establishment of another company may be generated.

The determination unit 102 determines similarity between the first answer sentence and a second answer sentence generated by inputting the first question sentence to the language model before update using the at least one piece of training data. The similarity between the second answer sentence and the first answer sentence means the degree of similarity between contents of the answer sentences. The same applies to “similarity” in the following description, which means the degree of similarity between contents of sentences expressed by natural language.

In addition, a similarity determination result of the determination unit 102 may indicate whether or not the answer sentences are similar to each other, or may indicate the degree of similarity. A method of determining the similarity is not particularly limited. For example, the determination unit 102 may determine the similarity between the first answer sentence and the second answer sentence by using the language model as described above. Furthermore, for example, the determination unit 102 may convert each of the first answer sentence and the second answer sentence into a vector and calculate similarity between the vectors. The determination of the similarity using the language model will be described in a second example embodiment.

As described above, the information processing apparatus 1 according to the present example embodiment adopts a configuration including: the generation control unit 101 that inputs the first question sentence regarding the content of the target document to the language model updated by machine learning using at least one piece of training data in which an answer sentence to a question sentence regarding the content of the target document is associated with the question sentence to generate the first answer sentence; and the determination unit 102 that determines the similarity between the first answer sentence and the second answer sentence generated by inputting the first question sentence to the language model before update using the at least one piece of training data.

Here, the second answer sentence is generated using the language model before update, and the first answer sentence is generated using the language model after update. Therefore, in a case where the first answer sentence and the second answer sentence are similar to each other, it can be said that the existing knowledge used in generating the second answer sentence has also been used in generating the first answer sentence. In this case, it can be said that effective learning (which can also be called forgetting of the existing knowledge) has not been performed at least for the first question sentence. On the other hand, in a case where the first answer sentence and the second answer sentence are dissimilar, it can be said that the existing knowledge used in generating the second answer sentence has not been used in generating the first answer sentence. In this case, it can be said that there is a possibility that effective learning has been performed for the first question sentence. Therefore, in the above configuration, a configuration in which the similarity between the second answer sentence and the first answer sentence is determined is adopted. As described above, in a case where the determination result of the determination unit 102 indicates that the first answer sentence and the second answer sentence are similar to each other, it can be said that there is a high possibility that effective learning has not been performed. Then, in this case, it cannot be said that the language model has been trained for the first question sentence. On the other hand, in a case where the determination result of the determination unit 102 indicates that the first answer sentence and the second answer sentence are dissimilar, it can be said that there is a possibility that effective learning has been performed for the first question sentence.

As described above, the determination result of the determination unit 102 is an indicator indicating the degree of possibility that effective learning has not been performed. Therefore, with the information processing apparatus 1, an effect of enabling automatic determination of the progress of training of the language model for the target document can be achieved.

Furthermore, by automatically determining the progress of training of the language model for the target document, it is also possible to end the training of the language model for the target document at an appropriate timing. Therefore, by using the information processing apparatus 1, it is possible to efficiently generate a language model optimized for generating an answer sentence for the target document.

### (Determination Program)

The above-described functions of the information processing apparatus 1 can also be implemented by a program. A determination program according to the present example embodiment causes a computer to function as: generation control means for inputting the first question sentence regarding the content of the target document to the language model updated by machine learning using at least one piece of training data in which an answer sentence to a question sentence regarding the content of the target document is associated with the question sentence to generate the first answer sentence; and determination means for determining the similarity between the first answer sentence and the second answer sentence generated by inputting the first question sentence to the language model before update using the at least one piece of training data. With the determination program, it is possible to automatically determine the progress of training of the language model for the target document.

### (Flow of Determination Method)

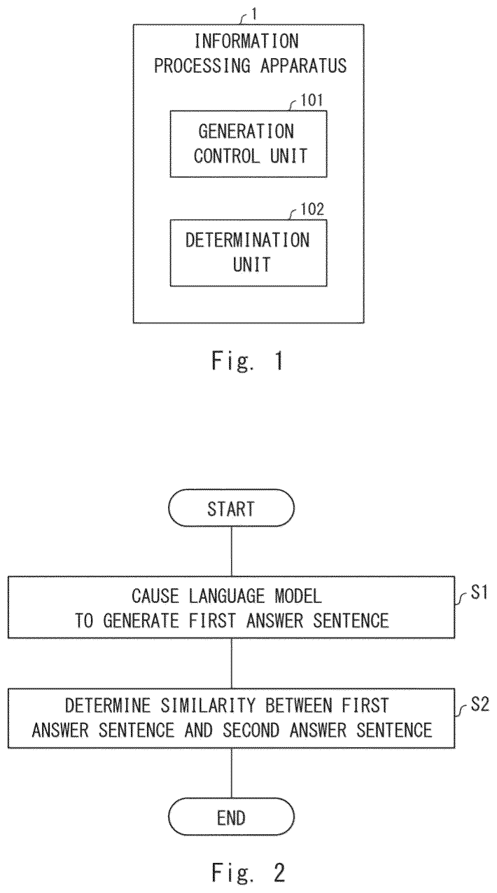

A flow of a determination method according to the present example embodiment will be described with reference to FIG. 2. FIG. 2 is a flowchart illustrating the flow of the determination method. An execution subject of each step in the determination method may be a processor included in the information processing apparatus 1 or may be a processor included in another apparatus, or execution subjects of the respective steps may be processors provided in different apparatuses.

In S1 (generation control processing), at least one processor inputs the first question sentence regarding the content of the target document to the language model updated by machine learning using at least one piece of training data in which an answer sentence to a question sentence regarding the content of the target document is associated with the question sentence to generate the first answer sentence.

In S2 (determination processing), at least one processor determines the similarity between the first answer sentence and the second answer sentence generated by inputting the first question sentence to the language model before update using the at least one piece of training data. The second answer sentence used in S2 may be generated in advance. A generation subject of the second answer sentence is arbitrary. For example, at least one processor may also perform processing of generating the second answer sentence before S2, and determine the similarity between the first answer sentence and the generated second answer sentence in S2.

As described above, the determination method according to the present example embodiment adopts a configuration including: the generation control processing of inputting, by at least one processor, the first question sentence regarding the content of the target document to the language model updated by machine learning using at least one piece of training data in which an answer sentence to the question sentence regarding the content of the target document is associated with the question sentence to generate the first answer sentence; and the determination processing of determining the similarity between the first answer sentence and the second answer sentence generated by inputting the first question sentence to the language model before update using the at least one piece of training data. Therefore, with the determination method according to the present example embodiment, it is possible to automatically determine the progress of training of the language model for the target document.

### Second Example Embodiment

The second example embodiment, which is an example of the example embodiment of the present disclosure, will be described in detail with reference to the drawings. An application range of each technology adopted in the present example embodiment is not limited to the present example embodiment. That is, each technology adopted in the present example embodiment can also be adopted in other example embodiments included in the present disclosure as long as no particular technical problem occurs. Each technology illustrated in each drawing referred to for describing the present example embodiment can also be adopted in other example embodiments included in the present disclosure as long as no particular technical problem occurs.

### (Configuration of Information Processing Apparatus 1A)

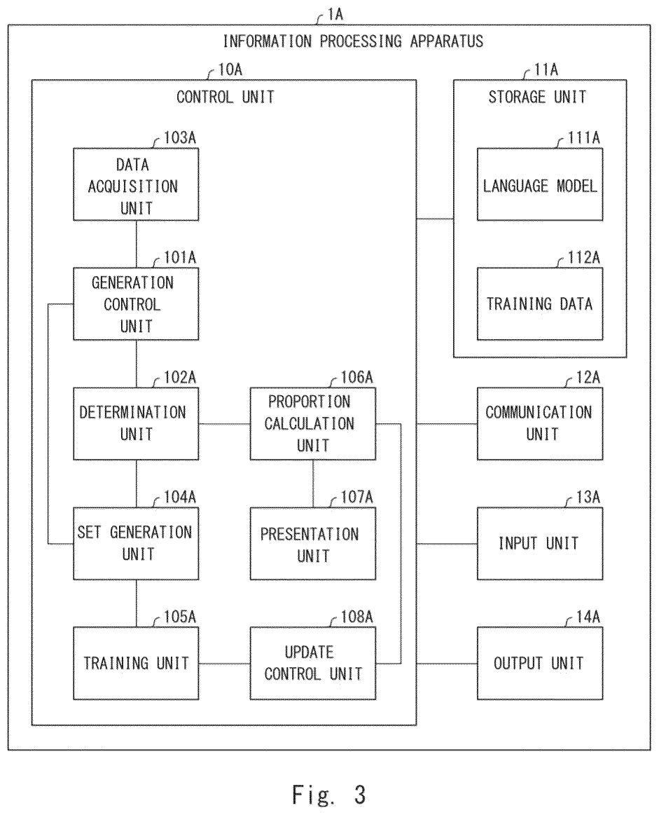

A configuration of an information processing apparatus 1A according to the present example embodiment will be described with reference to FIG. 3. FIG. 3 is a block diagram illustrating the configuration of the information processing apparatus 1A. The information processing apparatus 1A is an apparatus having a function of generating a language model suitable for generation of an answer sentence for a document that is a target (more precisely, updating the language model to increase accuracy of generation of an answer sentence for the document). The information processing apparatus 1A may be an apparatus whose main function is to update the language model, or may be a general-purpose apparatus having other functions. Furthermore, the information processing apparatus 1A may be a stationary apparatus or a portable apparatus.

As illustrated in FIG. 3, the information processing apparatus 1A includes a control unit 10A that integrally controls units of the information processing apparatus 1A, and a storage unit 11A that stores various types of data to be used by the information processing apparatus 1A. Furthermore, the information processing apparatus 1A includes a communication unit 12A for the information processing apparatus 1A to communicate with another apparatus, an input unit 13A that receives an input to the information processing apparatus 1A, and an output unit 14A for the information processing apparatus 1A to output data. Then, the control unit 10A includes a data acquisition unit 103A, a generation control unit 101A, a determination unit 102A, a set generation unit 104A, a training unit 105A, a proportion calculation unit 106A, a presentation unit 107A, and an update control unit 108A. In addition, the storage unit 11A stores a language model 111A and training data 112A. The proportion calculation unit 106A is described below in the items “Dissimilarity Rate/Similarity Rate between First Answer Sentence and Second Answer Sentence” and “Dissimilarity Rate/Similarity Rate between First Answer Sentence and Third Answer Sentence”.

The data acquisition unit 103A acquires a document to be learned (referred to as a target document similarly to the first example embodiment) by the language model 111A. As in the first example embodiment, the target document is a document whose content is to be learned by the language model 111A, and may include at least one sentence.

The generation control unit 101A performs control to cause the language model 111A to generate various sentences. More specifically, the generation control unit 101A causes the language model 111A to generate a sentence by inputting a prompt that instructs to generate a sentence to the language model 111A. A language model stored in an apparatus outside the information processing apparatus 1A may be used as the language model 111A. In this case, the generation control unit 101A transmits a prompt to the apparatus outside the information processing apparatus 1A to generate a sentence, and acquires the generated sentence from the apparatus.

For example, the generation control unit 101A can cause the language model 111A to generate a question sentence (first question sentence) regarding the content of the target document. In this case, the generation control unit 101A may generate a prompt that includes the target document and instructs to generate the question sentence regarding the content of the target document, and may input the generated prompt to the language model 111A to generate the first question sentence. Furthermore, the generation control unit 101A may repeatedly perform generation of the first question sentence so as to obtain a set of questions covering the entire target document.

Furthermore, for example, the generation control unit 101A can input the first question sentence to the language model 111A to generate a first answer sentence. In this case, the generation control unit 101A may generate a prompt that includes the first question sentence and instructs to generate an answer sentence to the first question sentence, and may input the generated prompt to the language model 111A to generate the first answer sentence. In a case where a plurality of first question sentences are generated, the generation control unit 101A causes the language model 111A to generate the first answer sentence for each of the first question sentences.

Furthermore, for example, the generation control unit 101A can also input the first question sentence to the language model 111A before update using at least one piece of training data to generate a second answer sentence. A method of generating the second answer sentence is similar to a method of generating the first answer sentence except that the language model 111A before update is used. In a case where a plurality of first question sentences are generated, the generation control unit 101A causes the language model 111A before update to generate the second answer sentence for each of the first question sentences.

Furthermore, for example, the generation control unit 101A can cause the language model 111A to generate a third answer sentence to the first question sentence by referring to at least a part of the target document. In this case, the generation control unit 101A may generate a prompt that includes the first question sentence and a part of or the entire target document and instructs to generate an answer sentence based on the content of the target document, and may input the generated prompt to the language model 111A to generate the third answer sentence. In a case where a plurality of first question sentences are generated, the generation control unit 101A causes the language model 111A to generate the third answer sentence for each of the first question sentences. A pair of the first question sentence and the third answer sentence to the first question sentence generated in this way serves as training data for updating the language model 111A such that an answer sentence based on the content of the target document can be generated.

Similarly to the language model described in the first example embodiment, the language model 111A is a language model generated by machine learning such that an answer sentence to a question regarding the content of the target document can be generated. As described above, the language model 111A can also be used to generate a question sentence regarding the content of the target document, and can also be used to determine similarity between sentences.

The determination unit 102A determines the similarity between the sentences. In the present example embodiment, an example in which the determination unit 102A determines the similarity by using the language model 111A will be described, but a similarity determination method is arbitrary and is not limited to this example. Furthermore, the determination unit 102A may determine the similarity by using a language model different from the language model 111A.

Similarly to the determination unit 102 included in the information processing apparatus 1 according to the first example embodiment, the determination unit 102A determines similarity between the second answer sentence generated by inputting the first question sentence to the language model 111A before update using at least one piece of training data is performed and the first answer sentence generated by inputting the first question sentence to the language model 111A after update using the at least one piece of training data is performed.

The determination unit 102A also determines similarity between the first answer sentence and the third answer sentence, which is described below in detail. Furthermore, the determination unit 102A also determines similarity between a plurality of question sentences for the content of the target document being generated by the language model 111A.

The set generation unit 104A generates a set of question sentences including the plurality of question sentences generated by the language model 111A based on a result of determining the similarity between the plurality of question sentences by the determination unit 102A. Each question sentence included in the set generated by the set generation unit 104A is associated with the above-described third answer sentence and stored as training data 112A in the storage unit 11A. As described above, the information processing apparatus 1A also has a function of generating the training data 112A.

The training unit 105A updates the language model 111A by machine learning using the training data 112A. As described above, the training data 112A may be obtained by associating the third answer sentence (an answer sentence generated by causing the language model 111A to refer to at least a part of the target document) with the first question sentence regarding the content of the target document.

The presentation unit 107A presents various types of information to a user of the information processing apparatus 1A. The user of the information processing apparatus 1A is, for example, an operator who manages update of the language model 111A. An aspect of the presentation is not particularly limited. For example, the presentation unit 107A may present information by audio output, by display output, or by print output. In addition, an apparatus that presents information is also arbitrary. For example, the presentation unit 107A may cause the output unit 14A to present information. Furthermore, for example, the presentation unit 107A may cause a terminal apparatus or the like possessed by the user to present information by communication via the communication unit 12A.

The update control unit 108A controls the update of the language model 111A. More specifically, the update control unit 108A determines whether or not to end the update after the language model 111A is updated by the training unit 105A, and causes the training unit 105A to update the language model 111A in a case where it is determined not to end the update (that is, continue the update). The update control unit 108A repeats such processing until it is determined to end the update. As a result, the language model 111A capable of generating an answer sentence based on the content of the target document for various question sentences regarding the target document is generated.

As described above, the information processing apparatus 1A includes the generation control unit 101A that inputs the first question sentence regarding the content of the target document to the language model 111A updated by machine learning using at least one piece of training data in which an answer sentence to a question sentence regarding the content of the target document is associated with the question sentence to generate the first answer sentence, and the determination unit 102A that determines the similarity between the first answer sentence and the second answer sentence generated by inputting the first question sentence to the language model 111A before update using the at least one piece of training data. Therefore, similarly to the information processing apparatus 1, an effect of enabling automatic determination of the progress of training of the language model for the target document can be achieved.

### (Dissimilarity Rate/Similarity Rate Between First Answer Sentence and Second Answer Sentence)

As described above, the generation control unit 101A may cause the language model 111A to generate the first answer sentence and the second answer sentence for each of the plurality of first question sentences. Furthermore, in this case, the determination unit 102A may determine the similarity for each pair of the first answer sentence and the second answer sentence corresponding to the same first question sentence.

Then, in this case, the proportion calculation unit 106A may calculate a dissimilarity rate, which is a proportion of pairs of the first answer sentence and the second answer sentence whose contents are dissimilar among the plurality of pairs of the first answer sentence and the second answer sentence, based on the result of determining the similarity for each pair of the first answer sentence and the second answer sentence corresponding to the same first question sentence.

The dissimilarity rate calculated in this manner indicates a proportion of first question sentences for which a content of an answer sentence has been changed before and after training among the plurality of first question sentences, and serves as an indicator indicating the progress of training for the plurality of target first question sentences. Specifically, a high dissimilarity rate means that the training for the plurality of targeted first question sentences has progressed.

Therefore, with the above configuration, in addition to the effect obtained by the information processing apparatus 1, it is possible to achieve an effect of enabling obtaining of the indicator indicating the progress of training for the plurality of targeted first question sentences. The dissimilarity rate can be used, for example, to determine whether or not to end the update of the language model 111A.

Instead of calculating the dissimilarity rate, the proportion calculation unit 106A may calculate a similarity rate which is a proportion of pairs of the first answer sentence and the second answer sentence whose contents are similar to each other among the plurality of pairs of the first answer sentence and the second answer sentence. Similarly to the dissimilarity rate, the similarity rate serves as an indicator indicating the progress of training for the plurality of target first question sentences. A high similarity rate means that the training for the plurality of target question sentences has not progressed. Furthermore, the proportion calculation unit 106A may calculate both the dissimilarity rate and the similarity rate.

The presentation unit 107A may present the dissimilarity rate calculated by the proportion calculation unit 106A to the user. As a result, in addition to the effect obtained by the information processing apparatus 1, it is possible to achieve an effect of enabling the user to recognize the progress of training for the plurality of target first question sentences. In a case where the proportion calculation unit 106A calculates the similarity rate instead of the dissimilarity rate, the presentation unit 107A may present the similarity rate. In a case where the proportion calculation unit 106A calculates both the dissimilarity rate and the similarity rate, the presentation unit 107A may present both the similarity rate and the dissimilarity rate.

In a case where the dissimilarity rate is equal to or lower than a predetermined threshold, or in a case where the similarity rate is equal to or higher than a predetermined threshold, the training unit 105A may update the language model 111A by machine learning using the training data in which the third answer sentence based on the content of the target document is associated with the first question sentence. As a result, in addition to the effect obtained by the information processing apparatus 1, an effect of enabling, in a case where the progress of training for the plurality of target first question sentences is insufficient, automatic update of the language model 111A such that the insufficiency is resolved can be achieved.

Here, it is sufficient if the above-described first question sentence is a question sentence regarding the content of the target document, and the first question sentence may be, for example, a question sentence generated in the language model 111A or a question sentence input by the user.

Furthermore, the training unit 105A may update the language model 111A by machine learning using the training data 112A in which the third answer sentence based on the content of the target document is associated with the first question sentence corresponding to a pair of the first answer sentence and the second answer sentence for which the determination result of the determination unit 102A indicates that the first answer sentence and the second answer sentence are similar to each other. As a result, in addition to the effect obtained by the information processing apparatus 1, it is possible to achieve an effect of enabling efficient update mainly for the first question sentence for which a content of a corresponding answer sentence has not changed or has changed little before and after learning and which thus has a high likelihood of ineffective learning.

For example, the training unit 105A may first update the language model 111A by using a plurality of pieces of training data 112A stored in the storage unit 11A. Next, the training unit 105A may extract a pair of the first answer sentence and the second answer sentence for which the determination result indicates that the first answer sentence and the second answer sentence are similar to each other, from among the pairs of the first answer sentence and the second answer sentence which are determination targets of the determination unit 102A. Next, the generation control unit 101A may specify the first question sentence corresponding to each extracted pair. Then, the training unit 105A may update the language model 111A again by using the training data 112A including the first question sentence specified as described above among the pieces of training data 112A used for the update. As a result, it is possible to compensate for a portion that has not been sufficiently learned in the first update by the second update.

As described below, the determination unit 102A may determine the similarity between the first answer sentence and the third answer sentence included in the training data 112A. In this case, the training unit 105A may update the language model 111A by machine learning using the training data 112A in which the third answer sentence is determined to be dissimilar to the first answer sentence.

### (Dissimilarity Rate/Similarity Rate Between First Answer Sentence and Third Answer Sentence)

As described above, the generation control unit 101A may cause the language model 111A to generate the third answer sentence to the first question sentence by referring to at least a part of the target document. Then, the determination unit 102A may determine the similarity between the first answer sentence and the third answer sentence.

As a result, in addition to the effect obtained by the information processing apparatus 1, it is possible to achieve an effect of enabling obtaining of an additional indicator for automatically determining the progress of training of the language model 111A for the target document. A result of determining the similarity between the first answer sentence and the third answer sentence may be used as the indicator indicating the progress of training as it is, or at least one of the dissimilarity rate and the similarity rate calculated based on the result of determining the similarity may be used as the indicator indicating the progress of training as described below.

In the case of calculating at least one of the dissimilarity rate and the similarity rate, the generation control unit 101A generates a plurality of first answer sentences and a plurality of third answer sentences by using a plurality of first question sentences, thereby obtaining a plurality of pairs each including the first answer sentence and the third answer sentence corresponding to the same first question sentence. Furthermore, the determination unit 102A determines the similarity for each of the plurality of pairs. Then, the proportion calculation unit 106A may calculate the dissimilarity rate, which is a proportion of pairs of the first answer sentence and the third answer sentence whose contents are dissimilar among the plurality of pairs of the first answer sentence and the third answer sentence, based on the result of determining the similarity for each pair of the first answer sentence and the third answer sentence corresponding to the same first question sentence.

A method of calculating the dissimilarity rate between the first answer sentence and the third answer sentence is similar to a method of calculating the dissimilarity rate between the first answer sentence and the second answer sentence. In addition, the similarity rate may be calculated instead of the dissimilarity rate, or both the similarity rate and the dissimilarity rate may be calculated, similarly to a case where a pair of the first answer sentence and the second answer sentence is a target. In the following description, in order to distinguish the dissimilarity rate between the first answer sentence and the second answer sentence and the dissimilarity rate between the first answer sentence and the third answer sentence, the former is referred to as a “first dissimilarity rate” and the latter is referred to as a “second dissimilarity rate”. The same applies to the similarity rate.

The second dissimilarity rate indicates the progress of training for the plurality of targeted first question sentences (included in the training data 112A used for updating the language model 111A), more accurately, a proportion of answer sentences based on the content of the target document, which can be generated for the first question sentences. As described above, a high second dissimilarity rate means that the training has not progressed. Therefore, for example, the update control unit 108A may end the update of the language model 111A in a case where the second dissimilarity rate calculated after the update of the language model 111A is lower than a predetermined threshold, and may continue the update of the language model 111A in a case where the second dissimilarity rate is equal to or higher than the predetermined threshold.

On the other hand, the first dissimilarity rate indicates a proportion of pieces of training data in which a content of an answer sentence has changed after training among a plurality of piece of training data used for the training of the language model 111A. It can also be said that the first dissimilarity rate is an indicator indicating the degree of forgetting the existing knowledge used by the language model 111A before training to generate an answer (second answer). Since the change of the content of the answer sentence after training means that new knowledge has been acquired by forgetting the existing knowledge and an effect of the training has been achieved, the first dissimilarity rate can also be used as an indicator indicating the progress of training.

A high first dissimilarity rate means that the training has progressed. Therefore, for example, the update control unit 108A may end the update of the language model 111A in a case where the first dissimilarity rate calculated after the update of the language model 111A is equal to or higher than a predetermined threshold, and may continue the update of the language model 111A in a case where the first dissimilarity rate is lower than the predetermined threshold.

In a case where the content of the answer sentence generated by the trained language model 111A, that is, the first answer sentence, is dissimilar to the corresponding second answer sentence, such dissimilarity contributes to an increase in first dissimilarity rate regardless of whether or not the content of the first answer sentence is based on the content of the target document. Therefore, the first dissimilarity rate tends to have a higher value than the second dissimilarity rate. Therefore, in the case of determining whether or not to end the update of the language model 111A based on the first dissimilarity rate, the update of the language model 111A ends earlier than in the case of determining whether or not to end the update of the language model 111A based on the second dissimilarity rate. Which one of the first dissimilarity rate and the second dissimilarity rate is used to determine whether or not to end the update of the language model 111A is arbitrary, and which one is used may be determined according to accuracy required for the language model 111A, a time allowed for training, and the like.

Alternatively, the update control unit 108A may determine whether or not to end the update of the language model 111A based on both the first dissimilarity rate and the second dissimilarity rate. For example, the update control unit 108A may end the update of the language model 111A on condition that the first dissimilarity rate is equal to or higher than a first threshold and the second dissimilarity rate is lower than a second threshold. The same applies to a case where first and second similarity rates are used instead of the first and second dissimilarity rates.

### (Determination of Similarity Between First Answer Sentence and Fourth Answer Sentence)

The generation control unit 101A may cause the language model 111A before update to generate a fourth answer sentence to the first question sentence by referring to at least a part of the target document. Then, the determination unit 102A may determine similarity between the first answer sentence and the fourth answer sentence.

Here, in a case where the first answer sentence and the fourth answer sentence corresponding to a certain first question sentence are similar to each other, it can be said that an answer sentence based on the content of the target document can be generated for the first question sentence without updating the language model 111A. For such a first question sentence, even in a case where the first answer sentence and the second answer sentence are similar to each other, it cannot be said that the training is insufficient in some cases.

Therefore, in a case of calculating the first dissimilarity rate and the first similarity rate, the proportion calculation unit 106A may exclude a pair including the first answer sentence that is similar to the fourth answer sentence from among the pairs of the first answer sentence and the second answer sentence whose contents are similar to each other. In other words, the proportion calculation unit 106A may calculate, as the first similarity rate, a ratio of the total number of pairs including the first answer sentence that is similar to the fourth answer sentence among the pairs of the first answer sentence and the second answer sentence whose contents are similar to each other with respect to the total number of pairs of the first answer sentence and the second answer sentence. Furthermore, for example, in a case of calculating the first similarity rate and the first dissimilarity rate, the proportion calculation unit 106A may exclude a pair including the first answer sentence that is similar to the fourth answer sentence from among the pairs of the first answer sentence and the second answer sentence. With such a configuration, it is possible to calculate the valid first dissimilarity rate and the valid first similarity rate in consideration of the presence of the first question sentence for which an answer sentence based on the content of the target document can be generated without updating the language model 111A.

### (Amplification of Training Data 112A)

The generation control unit 101A may amplify the training data 112A used for updating the language model 111A. More specifically, the generation control unit 101A may cause the language model 111A to generate a new question sentence similar to the first question sentence corresponding to a pair of the first answer sentence and the second answer sentence for which the determination result of the determination unit 102A indicates that the first answer sentence and the second answer sentence are similar to each other. Then, the training unit 105A may update the language model 111A by machine learning using training data in which the third answer sentence based on the content of the target document is associated with the new question sentence. As a result, in addition to the effect obtained by the information processing apparatus 1, it is possible to achieve an effect of enabling an increase in accuracy in generating not only an answer question to the first question sentence for which the progress of training is insufficient but also an answer sentence to a question sentence similar to such first question sentence.

For example, the generation control unit 101A may extract a pair of the first answer sentence and the second answer sentence for which the determination result indicates that the first answer sentence and the second answer sentence are similar to each other, from among the pairs of the first answer sentence and the second answer sentence which are the determination targets of the determination unit 102A. Next, the generation control unit 101A may specify the first question sentence corresponding to each extracted pair. Then, the generation control unit 101A may generate a prompt that includes the specified first question sentence (that is, the first question sentence for which the training is considered to be insufficient) and instructs to generate a question sentence similar to the first question sentence, and may input the generated prompt to the language model 111A. As a result, the generation control unit 101A can cause the language model 111A to generate a new question sentence similar to the first question sentence for which the training is considered to be insufficient.

Then, the generation control unit 101A may input the generated question sentence and at least a part of the target document to the language model 111A to generate the third answer sentence based on the content of the target document and generate a pair of the new question sentence and the answer sentence, that is, new training data. As a result, the training unit 105A can update the language model 111A by machine learning using the new training data. The third answer sentence corresponding to the original first question sentence may be associated with the new question sentence to generate the training data. The new training data can also be generated with one prompt. In this case, it is sufficient if the generation control unit 101A uses a prompt that includes the first question sentence for which the training is considered to be insufficient and at least a part of the target document and instructs to generate a question sentence similar to the first question sentence, and an answer sentence to the question sentence based on the content of the target document. The third answer sentence may be set by the user.

### (Generation of Question Sentence/Answer Sentence)

As described above, the generation control unit 101A can cause the language model 111A to generate the first question sentence by inputting, to the language model 111A, a prompt including the target document and a sentence that instructs to generate the question sentence regarding the content of the target document.

For example, in a case where one first question sentence regarding the content of the target document is generated, the generation control unit 101A may use a prompt including a fixed phrase like “Read the document and create one question”. The generation control unit 101A can also generate a plurality of first question sentences by using a prompt in which “one” in the fixed phrase is changed to another number.

The above prompt may include a sentence indicating various constraint conditions. As a result, the first question sentence having a desired content can be easily generated. Examples of the above constraint conditions include generating a question related to the content of the target document, generating a question that can always be answered by reading the target document, using a specific word, and making a clear question that does not cause a person who has not read the target document to misunderstand. In addition, for example, a sentence instructing to generate a question that can be answered by YES or NO, generate a question asking a definition of a term described in the target document, generate a question asking a method described in the target document, or the like may be included in the prompt. Furthermore, in the case of repeatedly generating the first question sentence for one target document, the generation control unit 101A may use a prompt including a sentence instructing to generate a question from a different viewpoint so as not to have a similar content to the existing question, together with the previously generated first question sentence and the target document.

Furthermore, in a case where the generation control unit 101A causes the language model 111A to generate the third answer sentence to the first question sentence, it is sufficient if the generation control unit 101A inputs, to the language model 111A, a prompt including a sentence instructing to generate an answer conceivable from the target document for the question, together with the first question sentence and the target document. As a result, it is possible to cause the language model 111A to generate the third answer sentence based on a description content of the target document. The generation control unit 101A can also similarly generate the first answer sentence and the second answer sentence. However, in a case where the first answer sentence and the second answer sentence are generated, the generation control unit 101A does not input the target document or a part thereof to the language model 111A.

The generation control unit 101A can also generate a pair of the first question sentence and the third answer sentence. In this case, it is sufficient if the generation control unit 101A uses a prompt that includes the target document and instructs to generate a question sentence related to the content of the target document and an answer sentence to the question sentence. As a result, the generation control unit 101A can generate a pair of the first question sentence and the third answer sentence, that is, the training data 112A with one prompt.

### (Similarity Determination)

As described above, the determination unit 102A determines the similarity by using the language model 111A. Specifically, the determination unit 102A determines the similarity by inputting a prompt including a plurality of question sentences that are similarity determination targets and a sentence instructing to output similarity between the question sentences to the language model 111A.

In the case of determining whether or not a determination target question sentence is similar to one or more previously generated question sentences, the determination unit 102A may use a prompt including a sentence like “Answer “YES” in a case where there is a question sentence similar to the target question sentence among the previously generated question sentences, or answer “NO” in a case where there is no similar question sentence”. In addition, in a case where there is a similar question sentence among the previously generated question sentences, the prompt may include a sentence instructing to output the question sentence. As a result, the user can confirm validity of the determination result of the determination unit 102A.

In addition, in the case of determining the degree of similarity between the determination target question sentence and one or more previously generated question sentences, it is sufficient if the determination unit 102A uses a prompt that instructs to provide a numerical value as the degree of similarity. For example, the determination unit 102A may use a prompt including a sentence like “Please rate the degree of similarity between the previously generated question sentences and the target question sentence using a numerical value from 0 to 1 for each of the previously generated question sentences. A numerical value closer to 1 represents a higher degree of similarity”.

Furthermore, the determination unit 102A may determine the similarity in consideration of the answer sentence to the question sentence. In this case, the determination unit 102A may input, to the language model 111A, a prompt including a plurality of pairs of a question sentence and an answer sentence that are similarity determination targets and a sentence instructing to output the similarity of each of the pairs.

Furthermore, the determination unit 102A may use a prompt including a sentence indicating a purpose, context, or background of similarity determination, or a similarity determination subject. As a result, it is possible to improve similarity determination accuracy. For example, the determination unit 102A may use a prompt including a sentence like “You are an assistant who determines whether or not there is a question sentence similar to the target question sentence among the previously generated question sentences”.

The determination unit 102A can also determine the similarity between the first answer sentence and the second answer sentence by using the language model 111A. As a result, in addition to the effects obtained by the information processing apparatus 1, it is possible to achieve an effect of enabling improvement of the similarity determination accuracy with the update of the language model 111A.

In the case of determining the similarity between the first answer sentence and the second answer sentence by using the language model 111A, it is sufficient if the determination unit 102A generates a prompt including the first answer sentence and the second answer sentence and including a sentence instructing to output the similarity between the answer sentences, and inputs the generated prompt to the language model 111A. Similarly, the determination unit 102A can determine the similarity between the first answer sentence and the third answer sentence, or can determine the similarity between the first answer sentence and the fourth answer sentence. The similarity determination result may indicate whether or not the answer sentences are similar to each other or may indicate the degree of similarity, similar to the case of determining the similarity between the question sentences.

### (Flow of Processing: Overall)

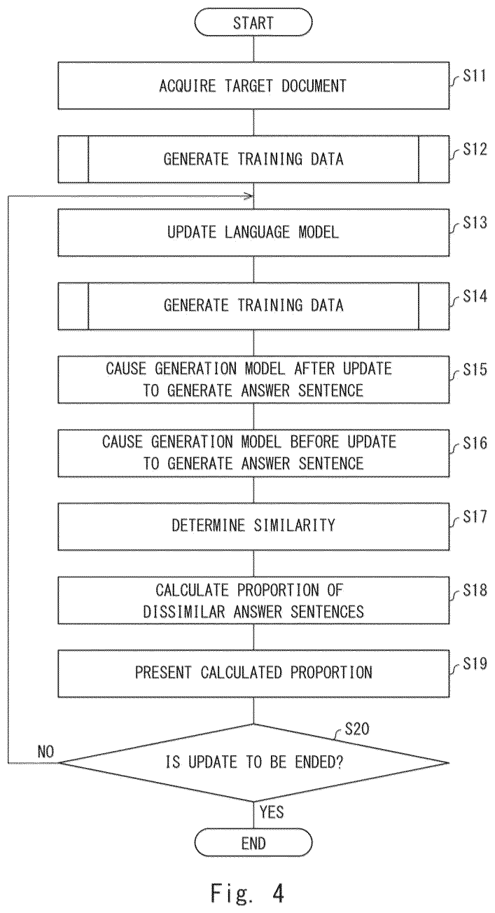

A flow of processing performed by the information processing apparatus 1A will be described with reference to FIG. 4. FIG. 4 is a flowchart illustrating an example of the processing performed by the information processing apparatus 1A. The flowchart of FIG. 4 includes each step of the determination method according to the present example embodiment.

In S11, the data acquisition unit 103A acquires the target document. A method of acquiring the target document is not particularly limited. For example, the data acquisition unit 103A may acquire the target document input via the input unit 13A, or may acquire the target document stored in another apparatus via the communication unit 12A. Furthermore, for example, the data acquisition unit 103A may acquire speech data of a description made orally, and acquire a text generated by performing speech recognition on the speech data as the target document.

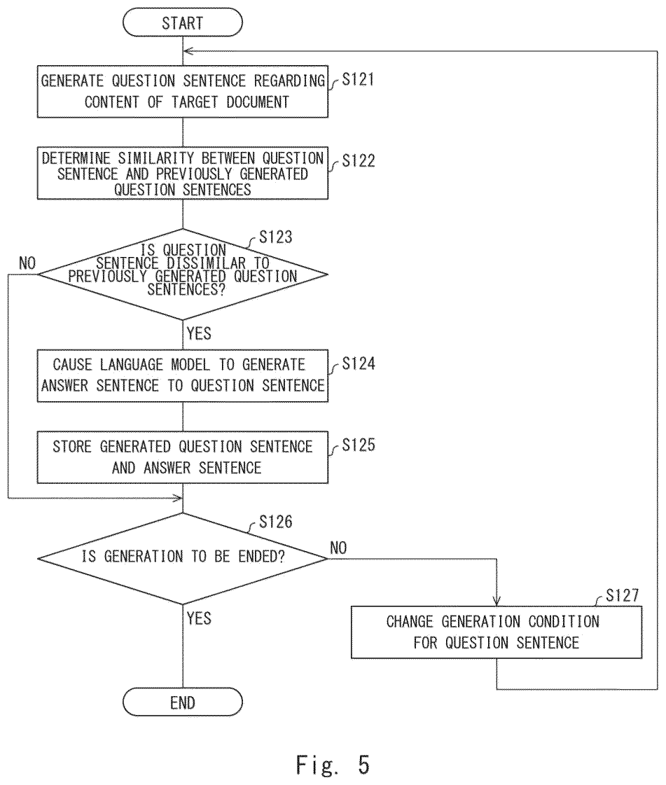

In S12, a plurality of pieces of training data 112A are generated using the target document acquired in S11. Details of the processing of generating the training data 112A are described below with reference to FIG. 5.

In S13, the training unit 105A updates the language model 111A by performing machine learning using the training data 112A generated in S12. Here, the training unit 105A does not delete the language model 111A before update but leaves the language model 111A before update.

In S14, similarly to S12, a plurality of pieces of training data 112A are generated using the target document acquired in S11. S12 and S14 are different in that, in S12, the language model 111A used for generating the training data 112A is the language model 111A before update of S13, and in S14, the language model 111A used for generating the training data 112A is the language model 111A after update of S13. In addition, the number of pieces of training data 112A to be generated and conditions related to the generation may be different between S12 and S14.

In S15 (generation control processing), the generation control unit 101A inputs the first question sentence regarding the content of the target document to the language model 111A updated in S13 by machine learning using at least one piece of training data 112A generated in S12 to generate the first answer sentence. The processing is performed for each of the first question sentences included in the plurality of pieces of training data 112A generated in S14. The answer sentence associated with the first question sentence in the training data 112A is an answer sentence generated by causing the language model 111A to refer to at least a part of the target document, that is, the third answer sentence. Furthermore, the processing of S15 may be performed for each of the first question sentences included in the plurality of piece of training data 112A generated in S12.

In S16, the generation control unit 101A inputs the first question sentence (included in the training data generated in S14) regarding the content of the target document acquired in S11 to the language model 111A before the update in S13 to generate the second answer sentence. The processing is performed for each of the first question sentences included in the plurality of pieces of training data 112A generated in S14. The steps of processing of S16 and S15 are different from each other in that, in S16, the language model used for generating the answer sentence is the language model before the update in S13, and in S15, the language model used for generating the answer sentence is the language model after the update in S13. The processing of S16 may be performed before the processing of S15, or these steps of processing may be performed in parallel.

In S17, the determination unit 102A determines the similarity between the third answer sentence (included in the training data generated in S14) generated by causing the language model 111A to refer to at least a part of the target document, and the first answer sentence generated in S15. The determination is performed for each of the third answer sentences included in the plurality of pieces of training data 112A generated in S14. The first answer sentence and the third answer sentence corresponding to the same first question sentence are similarity determination targets. It is not essential to determine the similarity between the first answer sentence and the third answer sentence, and the determination may be omitted.

In addition, in S17 (determination processing), the determination unit 102A determines the similarity between the second answer sentence generated in S16 and the first answer sentence generated in S15. Also in the determination, the first answer sentence and the second answer sentence corresponding to the same first question sentence are similarity determination targets. The determination is performed for each of the plurality of first answer sentences generated in S15.

In S18, the proportion calculation unit 106A calculates a proportion of pairs of the first answer sentence and the third answer sentence whose contents are dissimilar among the plurality of pairs of the first answer sentence and the third answer sentence, that is, the second dissimilarity rate, based on the determination result of S17. For example, in a case where the determination result of S17 indicates whether the contents are similar or dissimilar, it is sufficient if the proportion calculation unit 106A sets, as the second dissimilarity rate, a value obtained by dividing the number of pairs for which it is determined that the contents are dissimilar by the total number of pairs. Furthermore, in a case where the determination result of S17 is a numerical value indicating the similarity, it is sufficient if the proportion calculation unit 106A calculates the second dissimilarity rate by regarding a pair whose similarity is equal to or higher than a predetermined threshold as being similar and regarding a pair whose similarity is lower than the predetermined threshold as being dissimilar. In a case where the determination of the similarity between the first answer sentence and the third answer sentence is omitted, the calculation of the second dissimilarity rate is also omitted.

Further, in S18, the proportion calculation unit 106A calculates a proportion of pairs of the first answer sentence and the second answer sentence whose contents are dissimilar among the plurality of pairs of the first answer sentence and the second answer sentence, that is, the first dissimilarity rate, based on the determination result of S17. A method of calculating the first dissimilarity rate is similar to a method of calculating the second dissimilarity rate.

In S19, the presentation unit 107A presents the proportions calculated in S18, that is, the first dissimilarity rate and the second dissimilarity rate, to the user by causing the output unit 14A to output the proportions, for example.

In S20, the update control unit 108A determines whether or not to end the update of the language model 111A. In a case where affirmative determination (YES) is made in S20, the processing of FIG. 4 ends. It is sufficient if a condition for ending the update (hereinafter, referred to as an end condition) is determined in advance. For example, a condition that the second dissimilarity rate is lower than a predetermined threshold may be set as the end condition. Furthermore, for example, a condition that the first dissimilarity rate is equal to or higher than a predetermined threshold may be set as the end condition, or a condition that the second dissimilarity rate is lower than a predetermined threshold and the first dissimilarity rate is equal to or higher than a predetermined threshold may be set as the end condition.

Alternatively, for example, a condition that the user performs a predetermined operation for ending the update may be set as the end condition. In this case, the user may determine whether or not to end the update with reference to the first dissimilarity rate and the second dissimilarity rate presented in S19.

In a case where negative determination (NO) is made in S20, the processing returns to the processing of S13, and the language model 111A is updated. In S13 transitioning from S20, the training unit 105A updates the language model 111A by using the training data 112A generated in S14. At this time, the training unit 105A may extract the training data 112A including the second answer sentence for which the determination result of S17 indicates that the contents are dissimilar from among the pieces of training data 112A generated in S14, and update the language model 111A by using the extracted training data 112A.

After the processing of S17, the presentation unit 107A may present the determination result of S17 to the user. As a result, the user can recognize the similarity between the first answer sentence and the second answer sentence. In this case, since the user can determine whether or not to end the update of the language model 111A based on the presented similarity, S18 and S19 may be omitted, and in S20, it may be determined whether or not to end the update according to a user operation. Furthermore, at the point of presenting the determination result of S17, the presentation unit 107A preferably presents the first question sentence corresponding to each determination result. As a result, the user can recognize the first question sentence for which the training of the language model 111A is insufficient.

### (Flow of Processing: Generation of Training Data 112A)

Details of the processing of S12 of FIG. 4 will be described with reference to FIG. 5. FIG. 5 is a flowchart illustrating details of the processing of S12 of FIG. 4. As described above, the processing of S14 of FIG. 4 is similar to the processing of S12, and the training data 112A is generated in the flow illustrated in FIG. 5 also in S14 of FIG. 4. The question sentence included in the training data 112A generated in S14 of FIG. 4 is the above-described “first question sentence”. As described above, the question sentence included in the training data 112A generated in S12 of FIG. 4 may be the “first question sentence”.

In S121, the set generation unit 104A instructs the generation control unit 101A to generate the question sentence. Then, the generation control unit 101A causes the language model 111A to generate the question sentence according to the instruction. Specifically, the generation control unit 101A causes the language model 111A to generate the question sentence by inputting, to the language model 111A, a prompt including a sentence instructing to generate the question sentence regarding the content of the target document together with the target document acquired in S11 of FIG. 4. In a case where the question sentence generated in S121 is obviously inappropriate (for example, in a case where the question sentence is not established as a sentence), the set generation unit 104A may discard the question sentence and instruct the generation control unit 101A to generate a new question sentence.

In S122, the determination unit 102A determines the similarity between the question sentence generated in S121 and a question sentence generated before the question sentence. The flow of FIG. 5 is repeatedly performed until affirmative determination (YES) is made in S126, and the processing of S122 is omitted since there is no previously generated question sentence in the first loop. Then, in the second loop, similarity between the question sentence generated in S121 in the first loop and the question sentence generated in S121 in the second loop is determined. Furthermore, in the third loop, similarity between each of the question sentences generated in S121 in the first and second loops and a question sentence generated in S121 in the third loop is determined. The fourth and subsequent loops are similar to the third loop.

In S123, the set generation unit 104A determines whether or not a content of the question sentence generated in S121 is dissimilar to a content of the question sentence generated before the question sentence based on the determination result in S122. For example, the set generation unit 104A may determine that the contents are dissimilar in a case where the similarity determined by the determination unit 102A in S122 is equal to or lower than a predetermined threshold. In addition, in a case where the determination unit 102A determines whether the question sentences are similar or dissimilar in S122, it is sufficient if the set generation unit 104A sets the determination result in S122 as it is as the determination result in S123.

In the third and subsequent loops, the set generation unit 104A determines similarity between the most recently generated question sentence and each of a plurality of question sentences generated before the most recently generated question sentence, and makes affirmative determination (YES) as the determination result in S123 in a case where all the determination results indicate that the question sentences are dissimilar. On the other hand, in a case where at least one determination result indicates that the question sentences are similar to each other, the set generation unit 104A makes negative determination (NO) as the determination result in S123. In addition, the set generation unit 104A makes affirmative determination (YES) in S123 in the first loop.

In a case where affirmative determination (YES) is made in S123, the processing proceeds to S124. In S124, the generation control unit 101A causes the language model 111A to generate an answer sentence to the question sentence generated in S121 (the question sentence that is determined to be dissimilar to any of the previously generated question sentences). Specifically, the generation control unit 101A causes the language model 111A to generate an answer sentence by inputting, to the language model 111A, the question sentence, the target document, and a prompt that instructs to generate the answer sentence to the question sentence based on the content of the target document. The answer sentence generated in S124 is the third answer sentence described above. In a case where the answer sentence generated in S124 is obviously inappropriate (for example, in a case where the answer sentence is not established as a sentence), the set generation unit 104A may instruct the generation control unit 101A to regenerate the answer sentence.

In S125, the set generation unit 104A associates the question sentence generated in S121 with the answer sentence to the question sentence (the third answer sentence generated in S124) to obtain the training data 112A, and stores the training data 112A in the storage unit 11A. Furthermore, the set generation unit 104A may present the training data 112A to the user by causing the output unit 14A to output the training data 112A. After S125 ends, the processing proceeds to S126.

In a case where negative determination (NO) is made in S123, the processing proceeds to S126 without performing the steps of processing of S124 and S125. That is, for the question sentence for which negative determination (NO) has been made in S123, the third answer sentence is not generated and is not stored in the storage unit 11A. As a result, a set including, as elements, pairs of question sentences having dissimilar contents and the third answer sentence corresponding thereto is generated and stored as the training data 112A.

In S126, the set generation unit 104A determines whether or not to end the generation of the training data 112A. In a case where negative determination (NO) is made in S126, the set generation unit 104A instructs the generation control unit 101A to change a generation condition for the question sentence and generate the question sentence, and accordingly, the processing proceeds to S127. On the other hand, in a case where affirmative determination (YES) is made in S126, the processing of FIG. 5 ends.

It is sufficient if the determination condition in S126 is appropriately determined. For example, the set generation unit 104A may determine to end the generation of the training data 112A in a case where the number of repetitions of the steps of processing from S121 to S126 has reached a predetermined upper limit number. It is sufficient if the upper limit number is appropriately set according to the number of pieces of training data 112A to be generated, a volume of the target document, and the like. Furthermore, for example, the set generation unit 104A may determine to end the generation of the training data 112A in a case where the number of pieces of stored training data 112A has reached a predetermined upper limit number. In this case, it is sufficient if the number of pieces of training data 112A to be generated is set to the upper limit number.

In addition, as the steps of processing from S121 to S126 are repeated, the total number of pieces of training data 112A stored in S125 increases, and thus a proportion of question sentences determined to be dissimilar in S122 decreases. Then, in a case where the training data 112A stored in S125 covers the entire target document, the proportion of the question sentences determined to be dissimilar in S122 becomes zero or a value close to zero.

Therefore, for example, the set generation unit 104A may determine to end the generation of the training data 112A in a case where a proportion of question sentences that are dissimilar to any of the previously generated question sentences among a plurality of question sentences generated by the latest steps of processing from S121 to S126 repeated a predetermined number of times is equal to or lower than a predetermined threshold. As a result, it is possible to achieve an effect of enabling ending of the generation of the training data 112A at an appropriate timing and generation of a set of pieces of training data 112A covering the entire target document without bias.

For example, in a case where the predetermined number of times is set to five times and the threshold is set to ⅕, the set generation unit 104A ends the generation of the training data 112A in a case where the number of question sentences determined to be dissimilar in S122 among the most recently generated five question sentences is zero or 1. The threshold may be set to zero. In this case, in a case where all of a predetermined number of question sentences generated most recently are determined to be dissimilar in S122, in other words, in a case where the determination result of S122 indicates that the question sentences are dissimilar a predetermined number of times, the set generation unit 104A ends the generation of the training data 112A.

In S127, the generation control unit 101A changes the generation condition for the question sentence. After S127, the processing returns to S121, and the generation control unit 101A applies the changed generation condition and causes the language model 111A to generate a new question sentence.

The generation condition to be changed in S127 is arbitrary and may be determined in advance. For example, the generation control unit 101A may change a value of a randomness parameter (for example, a temperature parameter) in the language model 111A such that more various question sentences are generated. The randomness parameter is a hyperparameter for controlling diversity of options in the language model 111A, and by adjusting the randomness parameter, it is possible to generate various question sentences by the language model 111A.

Furthermore, in S127, the generation control unit 101A may change a prompt to be input to the language model 111A. In this case, a plurality of types of prompts may be prepared in advance. In addition, a plurality of patterns of constituent elements of the prompt may be prepared. In this case, the generation control unit 101A can change the generation condition by changing a combination of the constituent elements.

It is not always necessary to change the generation condition for the question sentence every time negative determination (NO) is made in S126. For example, the generation condition for the question sentence may be changed every time the cumulative number of times negative determination (NO) is made in S126 reaches a predetermined number.

Furthermore, the training data 112A may be generated for each chunk obtained by dividing the target document into a plurality of sections. A method of setting the chunk is arbitrary, and for example, the user may set each chunk. Furthermore, a boundary (for example, a content-based boundary such as a chapter, a section, or a paragraph, or a mechanical boundary such as a page) in the target document may be detected, and the chunk may be automatically set by the boundary. In addition, a chunk in which the number of characters included in one chunk becomes a predetermined value can be automatically set.

The processing in the case of generating the training data 112A for each chunk is performed by replacing the “target document” in the description of FIG. 5 described above with the “chunk of the target document”. Then, in a case where the training data 112A is generated for each chunk, the processing of FIG. 5 is performed for each of a plurality of chunks. Furthermore, in a case where the training data 112A is generated for each chunk, an answer sentence included in the generated training data, that is, the third answer sentence, is generated by referring to a part of the target document (a part of the chunk used to generate the third answer sentence).

The above-described method of generating the training data 112A is merely an example. For example, in S121, a pair of a question sentence and an answer sentence (third answer sentence) may be generated by using a prompt that includes at least a part of the target document and instructs to generate the question sentence and the answer sentence. In this case, the processing of S124 is omitted.

Further, the generation control unit 101A may first generate a plurality of question sentences. In this case, the set generation unit 104A may generate a set of question sentences by extracting some of the plurality of question sentences such that a proportion of question sentences that are dissimilar to other question sentences among the plurality of question sentences generated under the control of the generation control unit 101A is equal to or higher than a predetermined lower limit value. Even in a case where such a configuration is adopted, a set of questions covering the entire target document can be generated.

Further, the set generation unit 104A may generate a set of question sentences by repeating processing of causing the generation control unit 101A to generate a new question sentence until a proportion of question sentences that are dissimilar to other question sentences among a plurality of question sentences generated under the control of the generation control unit 101A becomes equal to or lower than a predetermined upper limit value in a case where the proportion exceeds the upper limit value. Even in a case where such a configuration is adopted, a set of questions covering the entire target document can be generated.

As the training data 112A is generated for each chunk, the training data 112A can reliably cover the entire target document. In this case, the set generation unit 104A may be omitted, and a predetermined number of pieces of training data 112A may be generated for each chunk.

### Implementation Example by Software

Some or all of the functions of the information processing apparatuses 1 and 1A may be implemented by hardware such as an integrated circuit (IC chip) or may be implemented by software.

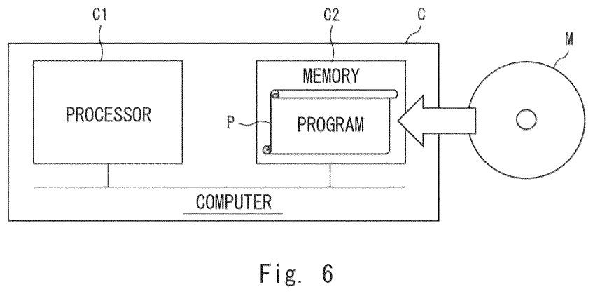

In the latter case, the information processing apparatuses 1 and 1A are implemented, for example, by a computer that executes a command of a program that is software for implementing each function. An example of such a computer (hereinafter, referred to as a computer C) is illustrated in FIG. 6. FIG. 6 is a block diagram illustrating a hardware configuration of the computer C that functions as the information processing apparatuses 1 and 1A.

The computer C includes at least one processor C1 and at least one memory C2. A program (determination program) P for causing the computer C to operate as the information processing apparatus 1 or 1A is recorded in the memory C2. In the computer C, the processor C1 reads the program P from the memory C2 and executes the program P, thereby implementing the functions of the information processing apparatus 1 or 1A.

For example, a central processing unit (CPU), a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used as the processor C1. For example, a flash memory, a hard disk drive (HDD), a solid state drive (SSD), or a combination thereof can be used as the memory C2.

The computer C may further include a random access memory (RAM) for loading the program P at the time of execution and temporarily storing various types of data. Furthermore, the computer C may further include a communication interface for transmitting and receiving data to and from another apparatus. The computer C may further include an input/output interface for connecting input/output devices such as a keyboard, a mouse, a display, and a printer.

In addition, the program P can be recorded in a non-transitory tangible recording medium M readable by the computer C. For example, a tape, a disk, a card, a semiconductor memory, a programmable logic circuit, or the like can be used as such a recording medium M. The computer C can acquire the program P via such a recording medium M. In addition, the program P can be transmitted via a transmission medium. For example, a communication network, a broadcast wave, or the like can be used as such a transmission medium. The computer C can also acquire the program P via such a transmission medium.

The program P can be stored and provided to Computer C using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Furthermore, each of the above-described functions of the information processing apparatuses 1 and 1A may be implemented by a single processor provided in a single computer, may be implemented by cooperation of a plurality of processors provided in a single computer, or may be implemented by cooperation of a plurality of processors provided in a plurality of computers. Furthermore, the program for causing the information processing apparatus 1 or 1A to implement the above-described functions may be stored in a single memory provided in a single computer, may be stored in a distributed manner in a plurality of memories provided in a single computer, or may be stored in a distributed manner in a plurality of memories provided in a plurality of computers.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### SUPPLEMENTARY NOTES

The present disclosure includes the technologies described in the following supplementary notes. However, the present disclosure is not limited to the technologies described in the following supplementary notes, and various modifications can be made within the scope described in the claims.

### Supplementary Notes A

### Supplementary Note A1

An information processing apparatus including: at least one memory storing instructions; and at least one processor configured to execute the instructions to; input a first question sentence regarding a content of a document that is a target to a language model updated by machine learning using at least one piece of training data in which an answer sentence to a question sentence regarding the content of the document is associated with the question sentence to generate a first answer sentence; and determine similarity between the first answer sentence and a second answer sentence generated by inputting the first question sentence to the language model before update using the at least one piece of training data.

### Supplementary Note A2

The information processing apparatus according to Supplementary Note A1, wherein the at least one processor is further configured to execute the instructions to; cause the language model to generate the first answer sentence and the second answer sentence for each of a plurality of the first question sentences, determine the similarity for each of pairs of the first answer sentence and the second answer sentence corresponding to the same first question sentence, and calculate at least one of a dissimilarity rate and a similarity rate based on a result of determining the similarity, the dissimilarity rate being a proportion of pairs of the first answer sentence and the second answer sentence whose contents are dissimilar among a plurality of pairs of the first answer sentence and the second answer sentence, and the similarity rate being a proportion of pairs of the first answer sentence and the second answer sentence whose contents are similar to each other among the plurality of pairs of the first answer sentence and the second answer sentence.

### Supplementary Note A3

The information processing apparatus according to Supplementary Note A2, wherein the at least one processor is further configured to execute the instructions to present at least one of the dissimilarity rate and the similarity rate to a user.

### Supplementary Note A4

The information processing apparatus according to Supplementary Note A2 or A3, wherein the at least one processor is further configured to execute the instructions to update the language model by machine learning using the training data in which a third answer sentence based on the content of the document is associated with the first question sentence in a case where the dissimilarity rate is equal to or lower than a predetermined threshold or the similarity rate is equal to or higher than a predetermined threshold.

### Supplementary Note A5

The information processing apparatus according to Supplementary Note A4, wherein the at least one processor is further configured to execute the instructions to update the language model by machine learning using the training data in which a third answer sentence based on the content of the document is associated with the first question sentence corresponding to a pair of the first answer sentence and the second answer sentence for which a determination result indicates that the first answer sentence and the second answer sentence are similar to each other.

### Supplementary Note A6

The information processing apparatus according to Supplementary Note A4 or A5, wherein the at least one processor is further configured to execute the instructions to; cause the language model to generate a new question sentence similar to the first question sentence corresponding to a pair of the first answer sentence and the second answer sentence for which a determination result indicates that the first answer sentence and the second answer sentence are similar to each other, and update the language model by machine learning using the training data in which a third answer sentence based on the content of the document is associated with the new question sentence.

### Supplementary Note A7

The information processing apparatus according to any one of Supplementary Notes A1 to A6, wherein the at least one processor is further configured to execute the instructions to; cause the language model to generate a third answer sentence to the first question sentence by referring to at least a part of the document, and determine similarity between the third answer sentence and the first answer sentence.

### Supplementary Note A8

The information processing apparatus according to any one of Supplementary Notes A1 to A7, wherein the at least one processor is further configured to execute the instructions to determine the similarity between the first answer sentence and the second answer sentence by using the language model.

### Supplementary Notes B

### Supplementary Note B1

A determination method executed by at least one processor, the determination method including: generation control processing of inputting a first question sentence regarding a content of a document that is a target to a language model updated by machine learning using at least one piece of training data in which an answer sentence to a question sentence regarding the content of the document is associated with the question sentence to generate a first answer sentence; and determination processing of determining similarity between the first answer sentence and a second answer sentence generated by inputting the first question sentence to the language model before update using the at least one piece of training data.

### Supplementary Note B2

The determination method according to Supplementary Note B1, in which the at least one processor causes the language model to generate the first answer sentence and the second answer sentence for each of a plurality of the first question sentences, determines the similarity for each of pairs of the first answer sentence and the second answer sentence corresponding to the same first question sentence, and performs proportion calculation processing of calculating at least one of a dissimilarity rate and a similarity rate based on a result of determining the similarity, the dissimilarity rate being a proportion of pairs of the first answer sentence and the second answer sentence whose contents are dissimilar among a plurality of pairs of the first answer sentence and the second answer sentence, and the similarity rate being a proportion of pairs of the first answer sentence and the second answer sentence whose contents are similar to each other among the plurality of pairs of the first answer sentence and the second answer sentence.

### Supplementary Note B3

The determination method according to Supplementary Note B2, further including presentation processing of presenting, by the at least one processor, at least one of the dissimilarity rate and the similarity rate to a user.

### Supplementary Note B4

The determination method according to Supplementary Note B2 or B3, further including training processing of updating, by the at least one processor, the language model by machine learning using the training data in which a third answer sentence based on the content of the document is associated with the first question sentence in a case where the dissimilarity rate is equal to or lower than a predetermined threshold or the similarity rate is equal to or higher than a predetermined threshold.

### Supplementary Note B5

The determination method according to Supplementary Note B4, in which in the training processing, the at least one processor updates the language model by machine learning using the training data in which a third answer sentence based on the content of the document is associated with the first question sentence corresponding to a pair of the first answer sentence and the second answer sentence for which a determination result of the determination processing indicates that the first answer sentence and the second answer sentence are similar to each other.

### Supplementary Note B6

The determination method according to Supplementary Note B4 or B5, in which the at least one processor causes the language model to generate a new question sentence similar to the first question sentence corresponding to a pair of the first answer sentence and the second answer sentence for which a determination result of the determination processing indicates that the first answer sentence and the second answer sentence are similar to each other, and in the training processing, the at least one processor updates the language model by machine learning using the training data in which a third answer sentence based on the content of the document is associated with the new question sentence.

### Supplementary Note B7

The determination method according to any one of Supplementary Notes B1 to B6, in which the at least one processor causes the language model to generate a third answer sentence to the first question sentence by referring to at least a part of the document, and determines similarity between the third answer sentence and the first answer sentence.

### Supplementary Note B8

The determination method according to any one of Supplementary Notes B1 to B7, in which in the determination processing, the at least one processor determines the similarity between the first answer sentence and the second answer sentence by using the language model.

### Supplementary Notes C

### Supplementary Note C1

A determination program for causing a computer to function as: generation control means for inputting a first question sentence regarding a content of a document that is a target to a language model updated by machine learning using at least one piece of training data in which an answer sentence to a question sentence regarding the content of the document is associated with the question sentence to generate a first answer sentence; and determination means for determining similarity between the first answer sentence and a second answer sentence generated by inputting the first question sentence to the language model before update using the at least one piece of training data.

### Supplementary Note C2

The determination program according to Supplementary Note C1, in which the generation control means causes the language model to generate the first answer sentence and the second answer sentence for each of a plurality of the first question sentences, the determination means determines the similarity for each of pairs of the first answer sentence and the second answer sentence corresponding to the same first question sentence, and the computer is caused to further function as proportion calculation means for calculating at least one of a dissimilarity rate and a similarity rate based on a result of determining the similarity, the dissimilarity rate being a proportion of pairs of the first answer sentence and the second answer sentence whose contents are dissimilar among a plurality of pairs of the first answer sentence and the second answer sentence, and the similarity rate being a proportion of pairs of the first answer sentence and the second answer sentence whose contents are similar to each other among the plurality of pairs of the first answer sentence and the second answer sentence.

### Supplementary Note C3

The determination program according to Supplementary Note C2, in which the computer is caused to further function as presentation means for presenting at least one of the dissimilarity rate and the similarity rate to a user.

### Supplementary Note C4

The determination program according to Supplementary Note C2 or C3, in which the computer is caused to further function as training means for updating the language model by machine learning using the training data in which a third answer sentence based on the content of the document is associated with the first question sentence in a case where the dissimilarity rate is equal to or lower than a predetermined threshold or the similarity rate is equal to or higher than a predetermined threshold.

### Supplementary Note C5

The determination program according to Supplementary Note C4, in which the training means updates the language model by machine learning using the training data in which the third answer sentence based on the content of the document is associated with the first question sentence corresponding to a pair of the first answer sentence and the second answer sentence for which a determination result of the determination means indicates that the first answer sentence and the second answer sentence are similar to each other.

### Supplementary Note C6

The determination program according to Supplementary Note C4 or C5, in which the generation control means causes the language model to generate a new question sentence similar to the first question sentence corresponding to a pair of the first answer sentence and the second answer sentence for which a determination result of the determination means indicate that the first answer sentence and the second answer sentence are similar to each other, and the training means updates the language model by machine learning using the training data in which a third answer sentence based on the content of the document is associated with the new question sentence.

### Supplementary Note C7

The determination program according to any one of Supplementary Notes C1 to C6, in which the generation control means causes the language model to generate a third answer sentence to the first question sentence by referring to at least a part of the document, and the determination means determines similarity between the third answer sentence and the first answer sentence.

### Supplementary Note C8

The determination program according to any one of Supplementary Notes C1 to C7, in which the determination means determines the similarity between the first answer sentence and the second answer sentence by using the language model.

### Supplementary Notes D

### Supplementary Note D1

An information processing apparatus including at least one processor, in which the at least one processor executes generation control processing of inputting a first question sentence regarding a content of a document that is a target to a language model updated by machine learning using at least one piece of training data in which an answer sentence to a question sentence regarding the content of the document is associated with the question sentence to generate a first answer sentence, and determination processing of determining similarity between the first answer sentence and a second answer sentence generated by inputting the first question sentence to the language model before update using the at least one piece of training data.

The information processing apparatus may further include a memory. In addition, the memory may store a program for causing the at least one processor to execute each step of processing.

### Supplementary Note D2

The information processing apparatus according to Supplementary Note D1, in which the at least one processor causes the language model to generate the first answer sentence and the second answer sentence for each of a plurality of the first question sentences, determines the similarity for each of pairs of the first answer sentence and the second answer sentence corresponding to the same first question sentence, and performs proportion calculation processing of calculating at least one of a dissimilarity rate and a similarity rate based on a result of determining the similarity, the dissimilarity rate being a proportion of pairs of the first answer sentence and the second answer sentence whose contents are dissimilar among a plurality of pairs of the first answer sentence and the second answer sentence, and the similarity rate being a proportion of pairs of the first answer sentence and the second answer sentence whose contents are similar to each other among the plurality of pairs of the first answer sentence and the second answer sentence.

### Supplementary Note D3

The information processing apparatus according to Supplementary Note D2, in which the at least one processor performs presentation processing of presenting at least one of the dissimilarity rate and the similarity rate to a user.

### Supplementary Note D4

The information processing apparatus according to Supplementary Note D2 or D3, in which the at least one processor performs training processing of updating the language model by machine learning using the training data in which a third answer sentence based on the content of the document is associated with the first question sentence in a case where the dissimilarity rate is equal to or lower than a predetermined threshold or the similarity rate is equal to or higher than a predetermined threshold.

### Supplementary Note D5

The information processing apparatus according to Supplementary Note D4, in which in the training processing, the at least one processor updates the language model by machine learning using the training data in which the third answer sentence based on the content of the document is associated with the first question sentence corresponding to a pair of the first answer sentence and the second answer sentence for which a determination result of the determination processing indicates that the first answer sentence and the second answer sentence are similar to each other.

### Supplementary Note D6

The information processing apparatus according to Supplementary Note D4 or D5, in which in the generation control processing, the at least one processor causes the language model to generate a new question sentence similar to the first question sentence corresponding to a pair of the first answer sentence and the second answer sentence for which a determination result of the determination processing indicates that the first answer sentence and the second answer sentence are similar to each other, and in the training processing, the at least one processor updates the language model by machine learning using the training data in which the third answer sentence based on the content of the document is associated with the new question sentence.

### Supplementary Note D7

The information processing apparatus according to any one of Supplementary Notes D1 to D6, in which the at least one processor causes the language model to generate a third answer sentence to the first question sentence by referring to at least a part of the document, and determines similarity between the third answer sentence and the first answer sentence.

### Supplementary Note D8

The information processing apparatus according to any one of Supplementary Notes D1 to D7, in which in the determination processing, the at least one processor determines the similarity between the first answer sentence and the second answer sentence by using the language model.

### Supplementary Note E

A non-transitory recording medium recording a determination program for causing a computer to perform: generation control processing of inputting a first question sentence regarding a content of a document that is a target to a language model updated by machine learning using at least one piece of training data in which an answer sentence to a question sentence regarding the content of the document is associated with the question sentence to generate a first answer sentence; and determination processing of determining similarity between the first answer sentence and a second answer sentence generated by inputting the first question sentence to the language model before update using the at least one piece of training data.

Some or all of elements (e.g., structures and functions) specified in Supplementary Notes A2 to A8 dependent on Supplementary Note A1 may also be dependent on Supplementary Note E in dependency similar to that of Supplementary Notes A2 to A8 on Supplementary Note A1. Some or all of elements specified in any of Supplementary Notes may be applied to various types of hardware, software, and recording means for recording software, systems, and methods.

What is claimed is:

1. An information processing apparatus comprising:
at least one memory storing instructions; and
at least one processor configured to execute the instructions to;
input a first question sentence regarding a content of a document that is a target to a language model updated by machine learning using at least one piece of training data in which an answer sentence to a question sentence regarding the content of the document is associated with the question sentence to generate a first answer sentence; and
determine similarity between the first answer sentence and a second answer sentence generated by inputting the first question sentence to the language model before update using the at least one piece of training data.

2. The information processing apparatus according to claim 1, wherein the at least one processor is further configured to execute the instructions to;
cause the language model to generate the first answer sentence and the second answer sentence for each of a plurality of the first question sentences,
determine the similarity for each of pairs of the first answer sentence and the second answer sentence corresponding to the same first question sentence, and
calculate at least one of a dissimilarity rate and a similarity rate based on a result of determining the similarity, the dissimilarity rate being a proportion of pairs of the first answer sentence and the second answer sentence whose contents are dissimilar among a plurality of pairs of the first answer sentence and the second answer sentence, and the similarity rate being a proportion of pairs of the first answer sentence and the second answer sentence whose contents are similar to each other among the plurality of pairs of the first answer sentence and the second answer sentence.

3. The information processing apparatus according to claim 2, wherein the at least one processor is further configured to execute the instructions to present at least one of the dissimilarity rate and the similarity rate to a user.

4. The information processing apparatus according to claim 2, wherein the at least one processor is further configured to execute the instructions to update the language model by machine learning using the training data in a case where the dissimilarity rate is equal to or lower than a predetermined threshold or in a case where the similarity rate is equal to or higher than a predetermined threshold.

5. The information processing apparatus according to claim 4, wherein the at least one processor is further configured to execute the instructions to update the language model by machine learning using a training data in which a third answer sentence based on the content of the document is associated with the first question sentence corresponding to a pair of the first answer sentence and the second answer sentence for which the determination result indicates that the first answer sentence and the second answer sentence are similar to each other.

6. The information processing apparatus according to claim 4, wherein the at least one processor is further configured to execute the instructions to;
cause the language model to generate a new question sentence similar to the first question sentence corresponding to a pair of the first answer sentence and the second answer sentence for which the determination result indicates that the first answer sentence and the second answer sentence are similar to each other, and
update the language model by machine learning using a training data in which a third answer sentence based on the content of the document is associated with the new question sentence.

7. The information processing apparatus according to claim 1, wherein the at least one processor is further configured to execute the instructions to;
cause the language model to generate a third answer sentence to the first question sentence by referring to at least a part of the document, and
determine similarity between the third answer sentence and the first answer sentence.

8. The information processing apparatus according to claim 1, wherein the at least one processor is further configured to execute the instructions to determine the similarity between the first answer sentence and the second answer sentence by using the language model.

9. A determination method executed by at least one processor, the determination method comprising:
generation control processing of inputting a first question sentence regarding a content of a document that is a target to a language model updated by machine learning using at least one piece of training data in which an answer sentence to a question sentence regarding the content of the document is associated with the question sentence to generate a first answer sentence; and
determination processing of determining similarity between the first answer sentence and a second answer sentence generated by inputting the first question sentence to the language model before update using the at least one piece of training data.

10. A non-transitory recording medium recording a determination program for causing a computer to perform:
generation control processing of inputting a first question sentence regarding a content of a document that is a target to a language model updated by machine learning using at least one piece of training data in which an answer sentence to a question sentence regarding the content of the document is associated with the question sentence to generate a first answer sentence; and
determination processing of determining similarity between the first answer sentence and a second answer sentence generated by inputting the first question sentence to the language model before update using the at least one piece of training data.
